(19) United States
(12) Patent Application Publication
(10) Pub. No.: US 2010/0080998 A1
(43) Pub. Date: Apr. 1, 2010

(54) Epoxy resin composition, and cured material, semi-cured material, prepreg and composite substrate using the epoxy resin composition

(75) Inventors: Junichi Seki, Tokyo (JP); Kenji Tokuhisa, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/585,823

(22) Filed: Sep. 25, 2009

(30) Foreign Application Priority Data
Sep. 30, 2008 (JP) 2008-255763
Mar. 18, 2009 (JP) 2009-065873

(51) Int. Cl. B32B 15/092; C08G 59/00

(52) U.S. Cl. 428/418; 525/481

(57) ABSTRACT

The present invention provides an epoxy resin composition that is excellent in thermal conductivity and has improved high-temperature resistance and handleability. The epoxy resin composition comprises an epoxy compound having a mesogenic skeleton and a curing agent having a biphenylaralkyl skeleton. The biphenylaralkyl skeleton-containing curing agent preferably has a softening point of 110° C. or lower. The biphenylaralkyl skeleton-containing curing agent is preferably an amorphous curing agent.

### CROSS-REFERENCES TO RELATED APPLICATIONS

The entire disclosure of Japanese Patent Application No. 2009-065873, filed on Mar. 18, 2009, is expressly incorporated herein by reference.

### BACKGROUND

1. Technical Field

The present invention relates to an epoxy resin composition excellent in thermal conductivity and having improved high-temperature resistance and handleability. The invention also relates to a cured material, semi-cured material, prepreg, substrate and composite substrate using the above epoxy resin composition.

2. Related Art

Compositions containing a curing agent and an epoxy resin having a mesogenic skeleton are known as resin compositions having high thermal conductivity. For example, Japanese Patent No. 3885664 discloses a composition containing: an epoxy resin obtained by reacting an epoxy compound having a specific structure including a biphenyl skeleton and a phenolic compound such as 4,4′-dihydroxybiphenyl; and an amine curing agent such as 1,5-diaminonaphthalene.

### SUMMARY

However, cured materials of the epoxy resin composition disclosed in Japanese Patent No. 3885664 still have room for improvement in terms of thermal conductivity. Furthermore, the cured materials of the epoxy resin composition disclosed in Japanese Patent No. 3885664 do not have sufficient resistance to high temperatures, and have problems in that, when used in a high-temperature environment, for example, when used for a substrate with high thermal conductivity, their mechanical strength may sharply decrease as the temperature in the environment increases.

Moreover, since the epoxy resin composition disclosed in Japanese Patent No. 3885664 is formed using, as the epoxy resin and the curing agent, a highly crystalline material having a high melting point, the conditions for forming a cured material, semi-cured material and prepreg from this epoxy resin composition are strictly restricted, resulting in poor handleability. More specifically, when preparing a semi-cured material of this epoxy resin composition, i.e., the epoxy resin composition in a so-called B-stage state (e.g., a prepreg), the epoxy resin composition is normally required to be treated at a high temperature exceeding 120° C. so as to homogenize the composition and increase its moldability; however, such high-temperature treatment causes rapid progress of the hardening reaction of the epoxy resin composition. As a result, the above epoxy resin composition has a problem in that the temperature range where the epoxy resin composition can exhibit good moldability while being kept in a suitable partially-hardened state is narrow and the process tolerance is small.

In light of the above problems, an object of the present invention is to provide an epoxy resin composition excellent in thermal conductivity and having improved high-temperature resistance and handleability, and a cured material, semi-cured material, prepreg, substrate and composite substrate using the above epoxy resin composition.

In order to solve the above problems, the present inventors carried out extensive studies, and as a result, the present inventors found that the above problems can be solved by using a combination of a specific curing agent and a mesogenic skeleton-containing epoxy compound having excellent mechanical and thermal properties, thereby completing the invention.

Namely, the invention provides the following:

[1] an epoxy resin composition comprising:
an epoxy compound having a mesogenic skeleton; and
a curing agent having a biphenylaralkyl skeleton,
   [2] the epoxy resin composition according to [1] above, wherein the biphenylaralkyl skeleton is represented by the following formula:

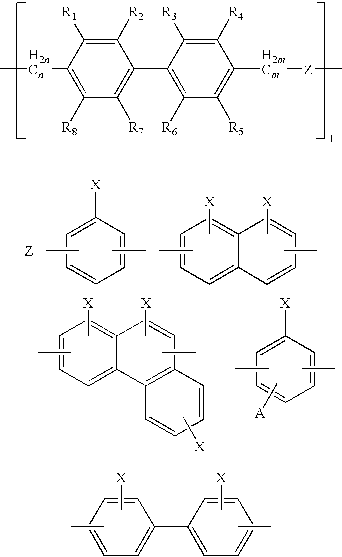

(wherein each of R₂, R₃, R₄, R₅, R₆, R₇ and R₈ represents a hydrogen atom or a monovalent alkyl group and each may be the same or different; each X represents a hydrogen atom or a hydroxyl group and each may be the same or different; A represents a hydroxyl group or a monovalent alkyl group; I, as mean value, is a number greater than 1; n and m are each integers of 1 or greater; and Z represents a group having at least one hydroxyl group),
[3] the epoxy resin composition according to [1] or [2] above, wherein the curing agent has a softening point of 110° C. or lower,
[4] the epoxy resin composition according to any of [1]-[3] above, wherein the curing agent is an amorphous curing agent,
[5] the epoxy resin composition according to any of [1]-[4], wherein the mesogenic skeleton is represented by the following formula:

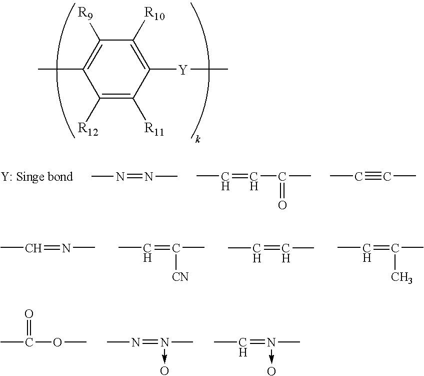

(wherein each of R₉, R₁₀, R₁₁ and R₁₂ represents a hydrogen atom or an alkyl group having 1 to 4 carbon atoms and each may be the same or different, and k is a number of 2 or greater),
[6] a cured material obtainable by hardening an epoxy resin composition, the epoxy resin composition comprising:
an epoxy compound having a mesogenic skeleton and
a curing agent having a biphenylaralkyl skeleton,
   [7] the cured material according to [6], wherein the cured material has a glass transition temperature of 130° C. or greater,
   [8] a semi-cured material obtainable by partially-hardening an epoxy resin composition, the epoxy resin composition comprising:
an epoxy compound having a mesogenic skeleton and
a curing agent having a biphenylaralkyl skeleton,
   [9] a prepreg at least comprising:
a core material; and
a semi-cured material obtainable by partially-hardening an epoxy resin composition that comprises an epoxy compound having a mesogenic skeleton and a curing agent having a biphenylaralkyl skeleton, and
   [10] a composite substrate comprising:
a cured material obtainable by hardening an epoxy resin composition that comprises an epoxy compound having a mesogenic skeleton and a curing agent having a biphenylaralkyl skeleton; and
a metal layer laminated on one surface or both surfaces of the cured material.

When measuring the properties of the epoxy resin composition configured as above and the properties of cured materials thereof, the present inventors found that, compared to conventional products, their thermal conductivities were further improved and their high-temperature resistance and handleability were also significantly improved. Although the specific mechanism that brings about the above effects is still yet to be understood, a possible mechanism is as follows:

It is believed that the high thermal activity in the prior-art epoxy resin compositions is realized by using an epoxy resin having a mesogenic skeleton and an amine curing agent having a naphthalene skeleton in combination and stacking a mesogenic group by an adjacency of the active hydrogen of the amine curing agent to increase the degree of orientation. However, the naphthalene skeleton-containing amine curing agent used in the prior art has relatively low molecular weight and is a highly crystalline material having a melting point exceeding 120° C., and thus causes the various problems described above.

On the other hand, in the epoxy resin composition according to the invention, a biphenylaralkyl skeleton, which is one of the mesogenic skeletons, is introduced into the curing agent so that the affinity of the curing agent with the mesogenic skeleton of the epoxy compound can be increased and high-efficiency stacking can be realized, and accordingly, high-temperature resistance can be improved. Also, since the crosslinking density and the density of the aromatic ring in the composition are increased compared to the case where a naphthalene skeleton-containing amine curing agent is used, the epoxy resin composition according to the invention has an increased glass transition temperature Tg, and a cured material thereof exhibits significantly improved high-temperature resistance.

Furthermore, the biphenylaralkyl skeleton-containing curing agent exhibits higher solubility in an organic solvent such as methyl ethyl ketone than the naphthalene skeleton-containing amine curing agent, and can soften or dissolve at a relatively low temperature. So, in the epoxy resin composition using the biphenylaralkyl skeleton-containing curing agent, the solvent can be dried at a relatively low temperature, which consequently makes it easy to keep the epoxy resin composition in a suitable partially-hardened state. Accordingly, the latitude for the heat treatment is expanded, and thus, the epoxy resin composition has enhanced process tolerance and significantly improved handleability. Note, however, the possible mechanisms are not limited to those described above.

When taking the above into consideration, the curing agent having a biphenylaralkyl skeleton is preferably an amorphous curing agent. Configuring the curing agent in the above way results in significantly enhanced handleability and high-temperature resistance compared to the prior-art products. Also, the curing agent having a biphenylaralkyl skeleton preferably has a softening point of 110° C. or lower, in order to exhibit good moldability at a relatively low temperature and thereby achieve improved handleability.

### BRIEF DESCRIPTION OF THE DRAWINGS

FIG. 1 is a graph showing the high-temperature resistance of epoxy resin cured materials of Example 1 and Comparative Examples 1 and 2.

FIG. 2 is a graph showing the high-temperature resistance of cured materials containing core material according to Examples 1 and 2 and Comparative Example 1.

### DESCRIPTION OF EXEMPLARY EMBODIMENTS

An embodiment of the invention is described below. The following embodiment is just an example for describing the invention, and the invention is not limited to this embodiment. The invention can be modified in various ways without departing from the gist of the invention.

The epoxy resin composition according to this embodiment comprises: an epoxy compound having a mesogenic skeleton; and a curing agent having a biphenylaralkyl skeleton.

Examples of the mesogenic skeleton-containing epoxy compound include, without limitation, glycidyl ethers, glycidyl esters and glycidyl amines having a mesogenic skeleton introduced therein.

The term “mesogenic skeleton” used herein refers to a partial structure that contributes to the development of a liquid crystalline property. Specific examples of the mesogenic skeleton include those represented by the following formula:

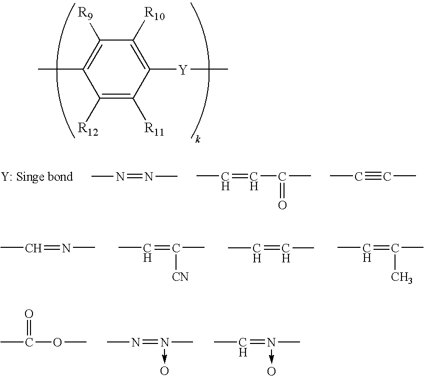

(wherein each of R₉, R₁₀, R₁₁ and R₁₂ represents a hydrogen atom or an alkyl group having 1 to 4 carbon atoms and each may be the same or different, and k is a number of 2 or greater).

Of these, the mesogenic skeleton is preferably one represented by the following formula:

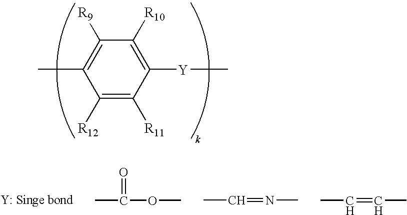

(wherein each of R₉, R₁₀, R₁₁ and R₁₂ represents a hydrogen atom or an alkyl group having 1 to 4 carbon atoms and each may be the same or different, and k is a number of 2 or greater).

In order to further improve thermal conductivity, it is preferable that the mesogenic skeleton-containing epoxy compound is a reaction product (prepolymer) obtainable by reacting a glycidyl ether having, in the molecule thereof, a biphenyl skeleton and two or more epoxy groups (such as biphenyl glycidyl ether and tetramethylbiphenyl glycidyl ether) with a polyfunctional phenol having a biphenyl skeleton (such as 4,4′-dihydroxy biphenyl and 4,4′-dihydroxy tetramethylbiphenyl). It is believed that when using the above reaction product, a high-order structure is likely to be formed during the later described reaction with a curing agent, due to the stacked mesogenic skeleton and biphenylaralkyl skeleton and the array thereof, which results in further improved thermal conductivity.

The epoxy resin composition may contain one type of the above mesogenic skeleton-containing epoxy compound alone, or contain two or more types thereof. The epoxy resin composition may also contain other epoxy compounds having no mesogenic skeleton.

Examples of the biphenylaralkyl skeleton-containing curing agent include, without limitation, polyfunctional phenols and aromatic amines having a biphenylaralkyl skeleton introduced therein.

Specific examples of the biphenylaralkyl skeleton include those represented by the following formula:

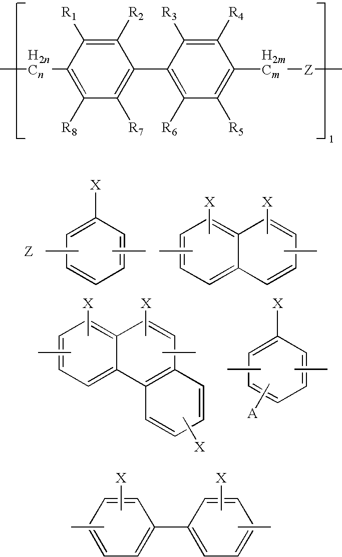

(wherein each of R₁, R₂, R₃, R₄, R₅, R₆, R₇ and R₈ represents a hydrogen atom or a monovalent alkyl group and each may be the same or different; each X represents a hydrogen atom or a hydroxyl group and each may be the same or different; A represents a hydroxyl group or a monovalent alkyl group; I, as mean value, is a number greater than 1; n and m are each integers of 1 or greater; and Z represents a group having at least one hydroxyl group).

In particular, from the viewpoint of the facility of industrial synthesis, the biphenylaralkyl skeleton-containing curing agent is preferably one represented by the following formula:

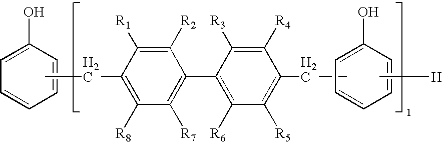

(wherein each of R₁, R₂, R₃, R₄, R₅, R₆, R₇ and R₈ represents a hydrogen atom or a monovalent alkyl group and each may be the same or different, and I, as mean value, is a number greater than 1).

The biphenylaralkyl skeleton-containing curing agent is preferably an amorphous curing agent from the viewpoint of handleability, and it is preferably a curing agent having no melting point from other viewpoints.

The biphenylaralkyl skeleton-containing curing agent preferably has a softening point of 110° C. or lower, more preferably 100° C. or lower, still more preferably 90° C. or lower, and particularly preferably 80° C. or lower, in order to exhibit good moldability at a relatively low temperature and improve handleability.

There are no particular limitations on the mixture ratio between the mesogenic skeleton-containing epoxy compound and the biphenylaralkyl skeleton-containing curing agent, and the biphenylaralkyl skeleton-containing curing agent is preferably used in an amount of from 5 to 40 parts by mass, more preferably from 10 to 30 parts by mass, based on 100 parts by mass of the mesogenic skeleton-containing epoxy compound, in terms of the solid content thereof. If the mesogenic skeleton-containing epoxy compound or the biphenylaralkyl skeleton-containing curing agent is used in excess, the heat-resistance of a hardened resin material tends to be reduced.

The epoxy resin composition may contain one type of the above biphenylaralkyl skeleton-containing curing agent alone, or contain two or more types thereof. The epoxy resin composition may also contain other curing agents having no biphenylaralkyl skeleton.

The epoxy resin composition is normally used in a state of being dissolved or dispersed homogenously in a solvent. There are no particular limitations on the solvent used herein as long as the above two components of the epoxy compound and the curing agent can be dissolved or dispersed in the solvent, and examples include: methyl ethyl ketone, methyl cellosolve, methyl isobutyl ketone, dimethyl formamide, propylene glycol monomethyl ether, toluene, xylene, acetone, and a solvent mixture thereof.

The epoxy composition may contain, if necessary, components other than the above described two components. Examples of such additional components include curing catalysts (hardening accelerators) such as phosphines and imidazoles (2-ethyl-4-methyl imidazole), coupling agents such as silane coupling agents and titanate coupling agents, inorganic fillers such as alumina and silica, fibers such as glass fibers and ceramics fibers, woven cloth, nonwoven cloth, flame retardants such as halogen and phosphorous compounds, diluents, plasticizers and lubricants, and they may be arbitrarily selected from among those known in the art.

In order to attain high-temperature resistance, the cured material of the epoxy resin composition preferably has a glass transition temperature under differential scanning calorimetry (DSC) of 130° C. or greater, more preferably 140° C. or greater, and still more preferably 150° C. or greater.

The epoxy resin composition preferably shows a storage elastic modulus at 200° C. of 2*10⁸ Pa or greater, more preferably 5*10⁸ Pa or greater.

By heating and drying the above epoxy resin composition, a semi-cured material of the epoxy resin composition, i.e., the epoxy resin composition in a so-called B-stage state, can be obtained. There are no particular limitations on the process for producing the semi-cured material, and a common process may be used. Typically, a process of heating and drying the epoxy resin composition put and held in a mold of a specific shape, and a process of applying the epoxy resin composition onto a resin film such as PET or a support such as a metal plate and then heating and drying the epoxy resin composition may be used. The epoxy resin composition according to this embodiment can be partially-hardened, for example, under the conditions of about 1 to 120 minutes at a temperature of 60 to 150° C., and the conditions are preferably about 10 to 90 minutes at a temperature of 70 to 120° C. Since the epoxy resin composition according to this embodiment can be treated at a relatively low temperature, it is superior to conventional products.

By heating the above epoxy resin composition or semi-cured material thereof until the hardening reaction has progressed sufficiently, a cured material can be obtained. There are no particular limitations on the process for producing the cured material, and a common process may be used. The heating conditions are typically about 1 to 300 minutes at 100 to 200° C. The production of the cured material may be performed under pressure.

The thermal conductivity of the cured material thus obtained is preferably 0.3 (W/m*K) or greater, more preferably 0.32 (W/m*K) or greater.

By adding, if necessary, a filler, etc., to the above epoxy resin composition, impregnating a core material with the resulting composition, for example, by applying the resulting composition to the core material or by immersing the core material in the resulting composition, and thereafter drying and partially-hardening the composition, a prepreg can be prepared. Also, by hardening, and if necessary, heating and pressing the prepreg, a substrate (cured material containing core material) can be prepared. Also, by laminating the prepreg and a metal layer such as a metal plate or metal foil and hardening or heating and pressing the laminated product, metal-clad laminate (composite substrate) can be prepared. Note that the preparation methods are not limited to those described above.

The thermal conductivity of the substrate and composite substrate obtained as indicated above is preferably 1.2 (W/m*K) or greater.

The core material used for the prepreg may be arbitrarily selected from various known materials. For example, glass fiber, metal fiber, natural fiber, synthesized fiber, and woven or nonwoven cloth formed, for example, of synthesized fiber such as polyester fiber or polyamide fiber may be used, although the applicable materials are not limited to the above. These core materials may be used alone or in combination of two or more thereof. There are no particular limitations on the thickness of the core material, and the thickness may be arbitrarily determined in accordance with the thickness of the prepreg or the laminate, a desired mechanical strength and size stability, etc. The thickness is normally within the range of about 0.03 to 0.20 mm.

The metal layer used for the composite substrate may be arbitrarily selected from various known materials. For example, metal plates and metal foil of Cu, Al, etc., may be used, although the applicable materials are not limited to the above. There are no particular limitations on the thickness of the metal layer, and the thickness is normally within the range of about 3 to 150 μm.

### EXAMPLES

The embodiment of the invention is more specifically described referring to the Synthesis examples, Examples and Comparative examples below. The terms “parts” and “%” used below indicate “parts by mass” and “% by mass” respectively.

### Epoxy Resin Composition

### Example 1

100 parts by mass of a difunctional crystalline epoxy resin (trade name: YL6121H, product of Japan Epoxy Resins Co., Ltd., epoxy equivalent: 175) and 28.53 parts by mass (equivalent: 93) of a dihydroxy biphenyl (abbreviated as DHBP) were placed in a three-mouth flask, and 128.53 parts by mass of methyl ethyl ketone were further added so that the solid content in the resulting mixture was 50% by mass. The resulting mixture was stirred after being set such that the mixture was brought under reflux. Upon observing the dissolution of the epoxy and phenol, the stirring reaction was carried out for twelve hours, and after that, the mixture was cooled to room temperature. In the resulting prepolymer solution, 28.15 parts by mass (equivalent ratio: 0.5) of a biphenylaralkyl curing agent represented by the formula shown below (trade name: HE200C, product of Air Water Inc., equivalent: 212, average I=1.2, softening point=75° C.) and 0.3355 part by mass of a curing catalyst (2-ethyl-4-methyl imidazole, abbreviated as 2E4Mz, product of Shikoku Chemicals Corporation) were mixed and dispersed homogeneously, resulting in the preparation of an epoxy resin composition of Example 1.

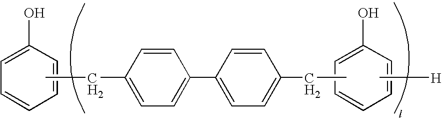

### Example 2

In the same manner as Example 1 other than replacing the curing agent with a biphenylaralkyl curing agent represented by the formula below (trade name: MEH7851, product of Meiwa Plastic Industries, Ltd., equivalent: 212, average I=10, softening point=73° C.), an epoxy resin composition of Example 2 was prepared.

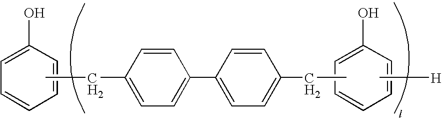

### Example 3

In the same manner as Example 1 other than replacing the curing agent with a biphenylaralkyl curing agent represented by the formula below (trade name: HE610C, product of Air Water Inc., equivalent: 202, average I=1, average h=1, softening point=79° C.) and using the biphenylaralkyl curing agent and the curing catalyst in an amount of 42.25 parts by mass and 0.3656 part by mass respectively, an epoxy resin composition of Example 3 was prepared.

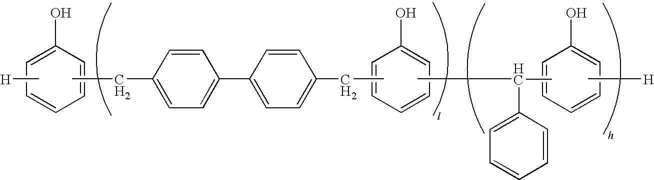

### Comparative Example 1

In the same manner as Example 1 other than replacing the curing agent with 1,5-diamino naphthalene (abbreviated as 1,5-DAN, equivalent: 79, melting point=187° C.) and using 1,5-diamino naphthalene and the curing catalyst in an amount of 12.11 parts by mass and 0.3011 part by mass respectively, an epoxy resin composition of Comparative Example 1 was prepared.

### Comparative Example 2

In the same manner as Example 1 other than replacing the curing agent with 1,5-dihydroxy naphthalene (abbreviated as 1,5-DHN, equivalent: 80, melting point=261° C.) and using 1,5-dihydroxy naphthalene and the curing catalyst in an amount of 12.85 parts by mass and 0.3014 part by mass respectively, an epoxy resin composition of Comparative Example 2 was prepared.

### Comparative Example 3

In the same manner as Example 1 other than replacing the curing agent with 1,2-dihydroxy naphthalene (abbreviated as 1,2-DHN, melting point=125° C.) and using 1,2-dihydroxy naphthalene and the curing catalyst in an amount of 12.85 parts by mass and 0.3014 part by mass respectively, an epoxy resin composition of Comparative Example 3 was prepared.

### Comparative Example 4

In the same manner as Example 1 other than replacing the curing agent with 1,3-dihydroxy naphthalene (abbreviated as 1,3-DHN, melting point=125° C.) and using 1,3-dihydroxy naphthalene and the curing catalyst in an amount of 12.85 parts by mass and 0.3014 part by mass respectively, an epoxy resin composition of Comparative Example 4 was prepared.

### Comparative Example 5

In the same manner as Example 1 other than replacing the curing agent with a phenolaralkyl curing agent represented by the formula below (trade name: HE100C, product of Air Water Inc., equivalent: 175, average p=1, softening point=72° C.) and using the phenolaralkyl curing agent and the curing catalyst in an amount of 22.24 parts by mass and 0.3228 part by mass respectively, an epoxy resin composition of Comparative Example 5 was prepared.

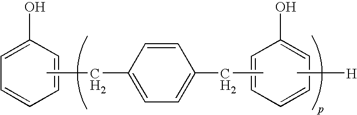

### <Semi-Cured Material and Cured Material>

The above obtained epoxy resin compositions of Examples 1 and 2 and Comparative Examples 1-5 were applied onto a PET film, and dried at 100° C. for 30 minutes to evaporate the solvent and bring the epoxy resin compositions in a B-stage state, and as a result, semi-cured materials of Examples 1 and 2 and Comparative Examples 1-5 were respectively prepared. The obtained partially-hardened B-stage materials were placed in a specific mold, and pressed for 15 minutes at 185° C. and 25 MPa using a hand-pressing machine. Then, by carrying out heat treatment at 185° C. for three hours, cured materials of Examples 1 and 2 and Comparative Examples 1-5 were respectively prepared.

The above obtained epoxy resin composition of Example 3 was applied onto a PET film, dried at 80° C. for 45 minutes, and further dried at 120° C. for 30 minutes to evaporate the solvent and bring the epoxy resin composition in a B-stage state, resulting in the preparation of a semi-cured material of Example 3. The obtained partially-hardened B-stage material was placed in a specific mold, and pressed for 15 minutes at 185° C. and 25 MPa using a hand-pressing machine. Then, by carrying out heat treatment at 185° C. for three hours, a cured material of Example 3 was prepared.

### <Preparation of Resin-Filler Cured Materials>

To each of the above obtained epoxy resin compositions of Examples 1 and 2 and Comparative Example 1, 10 to 80 parts of alumina beads (particle diameter: 500 nm to 100 μm) were added, and then were well stirred and dispersed to prepare a resin-filler solution.

The obtained resin-filler solution was applied onto a core material (glass fiber) and dried at 100° C. for 30 minutes to prepare a partially-hardened B-stage sheet. 2 to 10 sheets of the obtained partially-hardened B-stage sheet were laminated, placed in a specific mold, and pressed for 15 minutes at 185° C. and 25 MPa using a hand-pressing machine. Then, by carrying out heat treatment at 185° C. for three hours, cured materials containing core material according to each of Examples 1 and 2 and Comparative Example 1 was prepared.

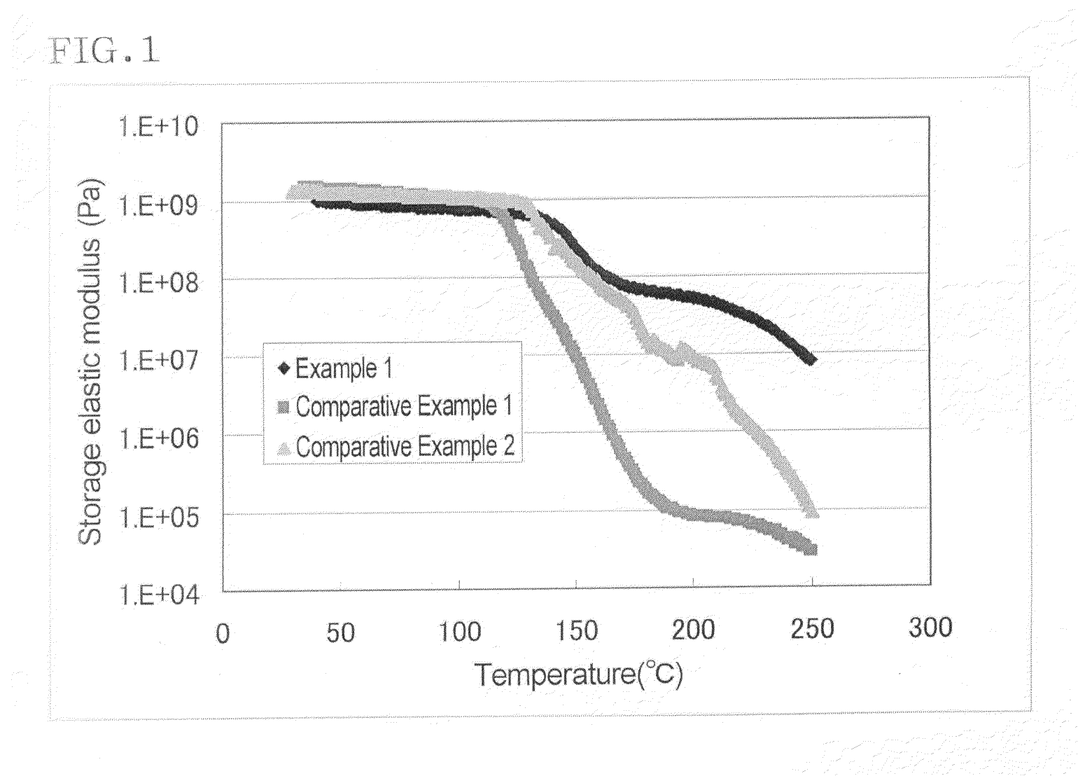

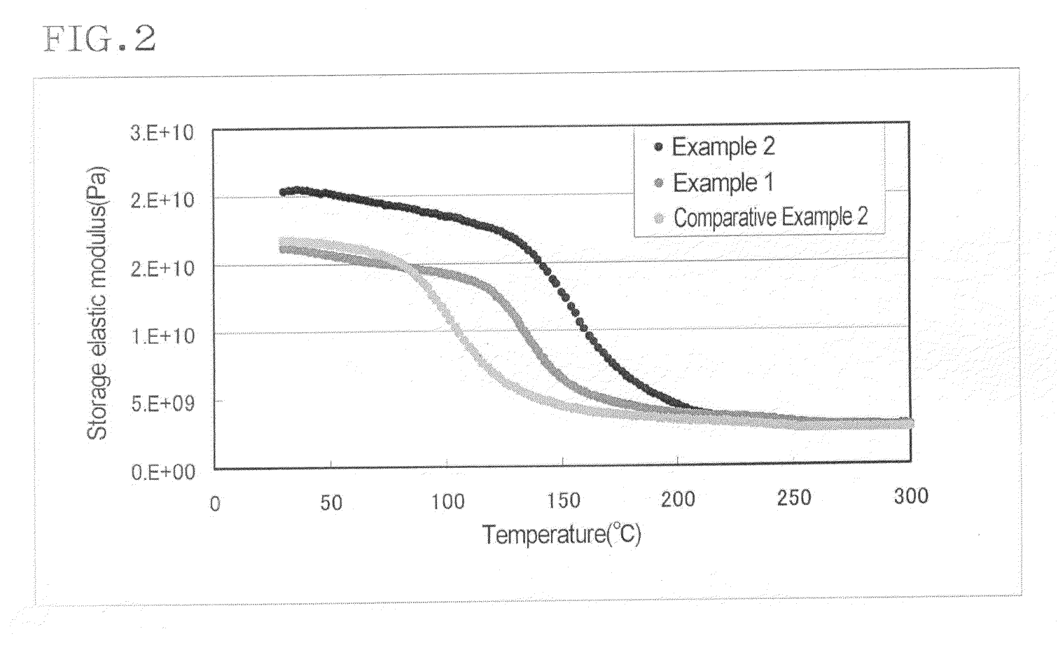

The evaluation results on the properties of the epoxy resin compositions of Examples 1-3 and Comparative Examples 1-5 and the cured materials thereof are shown in Table 1, and the evaluation results on the properties of the cured materials containing core material according to Examples 1 and 2 and Comparative Example 1 are shown in Table 2. Also, the measurement results of the storage elastic modulus of the epoxy resin cured materials of Example 1 and Comparative Examples 1 and 2 are shown in FIG. 1, and the measurement results of the storage elastic modulus of the cured materials containing core material according to Examples 1 and 2 and Comparative Example 1 are shown in FIG. 2.

TABLE 1

| Resin composition | | Example | | | Comparative Example | | | | |
|---|---|---|---|---|---|---|---|---|---|
| (parts by mass) | | 1 | 2 | 3 | 1 | 2 | 3 | 4 | 5 |
| Epoxy | YL6121H | 100 | 100 | 100 | 100 | 100 | 100 | 100 | 100 |
| resin | YX4000 | — | — | — | — | — | | | — |
| Phenol | DHBP | 28.53 | 28.53 | 28.53 | 28.53 | 28.53 | 28.53 | 28.53 | 28.53 |
| Curing | HE200C | 28.15 | — | — | — | — | — | — | — |
| agent | MEH7851 | — | 28.15 | — | — | — | — | — | — |
| | HE610C | — | — | 42.25 | — | — | — | — | — |
| | 1,5-DAN | — | — | — | 12.11 | — | — | — | — |
| | 1,5-DHN | — | — | — | — | 12.85 | — | — | — |
| | 1,2-DHN | — | — | — | — | — | 12.85 | — | — |
| | 1,3-DHN | — | — | — | — | — | — | 12.85 | — |
| | HE100C | — | — | — | — | — | — | — | 22.24 |
| Curing | 2E4Mz | 0.3355 | 0.3355 | 0.3656 | 0.3011 | 0.3014 | 0.3014 | 0.3014 | 0.3228 |
| catalyst | | | | | | | | | |

| | | | | | | | | |
|---|---|---|---|---|---|---|---|---|
| Thermal conductivity | 0.34 | 0.32 | 0.33 | 0.32 | 0.32 | 0.29 | 0.28 | 0.28 |
| (W/m * K) | | | | | | | | |
| Glass transition point | 159 | 158 | 156 | 110 | 129 | 119 | 119 | 132 |
| (° C.)/DSC | | | | | | | | |
| Glass transition point | 155 | | | 103 | 125 | | | |
| (° C.)/DMA | | | | | | | | |

TABLE 2

| | | | | Comparative |
|---|---|---|---|---|
| Resin composition | | Example | | Example |
| (parts by mass) | | 1 | 2 | 2 |
| Epoxy resin | YL6121H | 100 | 100 | 100 |
| | YX4000 | — | — | — |
| Phenol | DHBP | 28.53 | 28.53 | 28.53 |
| Curing agent | HE200C | 28.15 | — | — |
| | MEH7851 | — | 28.15 | — |
| | 1,5-DHN | — | — | 12.85 |
| Curing catalyst | 2E4Mz | 0.3355 | 0.3355 | 0.3014 |

| | | | |
|---|---|---|---|
| Thermal conductivity (W/m * K) | 1.31 | 1.46 | 1.08 |
| Glass transition point Tg | 166 | 175 | 116 |
| (° C.)/DMA | | | |

As can be seen from Table 1 and FIG. 1, the cured materials according to the invention were observed as having a thermal conductivity of 0.32 (W/m*K) or greater and also having a glass transition temperature of 130° C. or greater, i.e., excellent high-temperature resistance. Also, as can be seen from Table 2 and FIG. 2, the cured material containing core material according to the invention were observed as having a thermal conductivity of 1.2 (W/m*K) or greater and also having a glass transition temperature of 150° C. or greater, i.e., excellent high-temperature resistance.

Here, the chemical formulas of the crystalline epoxy resins YL6121H, DHBP and YX4000 used in the Examples and Comparative Examples above are shown below.

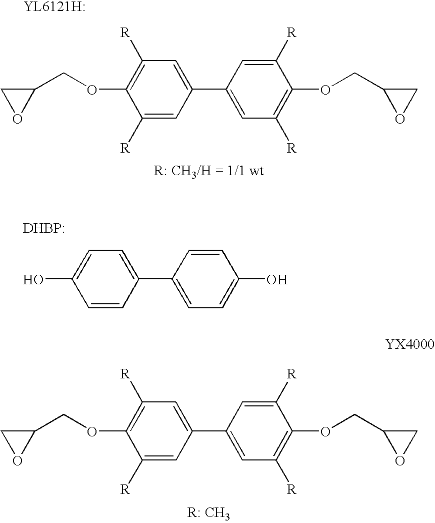

The evaluation was performed in the following manner:

### (1) Thermal Conductivity Measurement

A cured material or a cured material containing core material was stamped out in the form of a 1 mmø disk to prepare a measurement sample. The obtained measurement sample was subjected to thermal diffusivity measurement using a thermal diffusion coefficient measurement apparatus (trade name: TC Series, product of ULVAC-RIKO, Inc.). The specific heat was measured based on DSC using sapphire as a standard sample, the density was measured using a densimeter AD-1653 (product of A&D Co., Ltd.), and the thermal conductivity was calculated by assigning the measured values to equation (1) below.

λ=α*Cp*r (1)
α: thermal diffusivity
Cp: specific heat
r: density

### (2) High-Temperature Resistance (DMA)

A 4 mm by 25 mm hardened resin material and cured material containing core material having a thickness of 400 μm were prepared as measurement samples. The storage elastic modulus of each of the above samples was measured using a FT Rheospectra (DVE-V4 type, product of Rheology) by increasing the temperature from 25° C. to 300° C. at a rate of 5° C./min, and the inflection point in the storage elastic modulus was observed to be a glass transition point (Tg).

### (3) High-Temperature Resistance (DSC)

A cured material and a cured material containing core material were cut out so as to be in an amount of 10 to 20 mg. These samples were put in an aluminum pan for thermal analysis, and subjected to differential scanning calorimetry using a DSC apparatus (seiko 220) by increasing the temperature from 25° C. to 250° C. at a rate of 10° C./min. The inflection point in the change in specific heat was observed to be a glass transition point (Tg).

As described above, the epoxy resin composition according to the invention, and the cured materials, semi-cured materials, prepregs, substrates and composite substrates obtainable by using the above epoxy resin composition are excellent in thermal conductivity and have improved high-temperature resistance and handleability, and accordingly, in the field of electronic materials, they can be widely and effectively used for electronic parts as well as modules such as substrates with electronic parts, cooling sheets, and insulating materials.

According to the invention, it is possible to provide an epoxy resin composition that exhibits excellent thermal conductivity when hardened, as well as improved handleability and high-temperature resistance, and to provide a prepreg and semi-cured material obtainable by partially-hardening the above epoxy resin composition, and it is consequently possible to provide a cured material, substrate and composite substrate that have improved reliability and excellent thermal conductivity, easily at a low cost, resulting in improved productivity and economic efficiency.

1-10. (canceled)

11. An epoxy resin composition comprising:
an epoxy compound having a mesogenic skeleton; and
a curing agent having a biphenylaralkyl skeleton.

12. The epoxy resin composition according to claim 11, wherein the biphenylaralkyl skeleton is represented by the following formula: 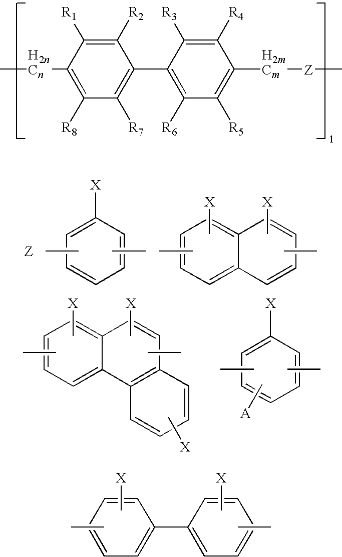
(wherein each of R₁, R₂, R₃, R₄, R₅, R₆, R₇ and R₈ represents a hydrogen atom or a monovalent alkyl group and each may be the same or different; each X represents a hydrogen atom or a hydroxyl group and each may be the same or different; A represents a hydroxyl group or a monovalent alkyl group; I, as mean value, is a number greater than 1; n and m are each integers of 1 or greater; and Z represents a group having at least one hydroxyl group).

13. The epoxy resin composition according to claim 12, wherein the curing agent has a softening point of 110° C. or lower.

14. The epoxy resin composition according to claim 12, wherein the curing agent is an amorphous curing agent.

15. The epoxy resin composition according to claim 13, wherein the curing agent is an amorphous curing agent.

16. The epoxy resin composition according to claim 12, wherein the mesogenic skeleton is represented by the following formula: 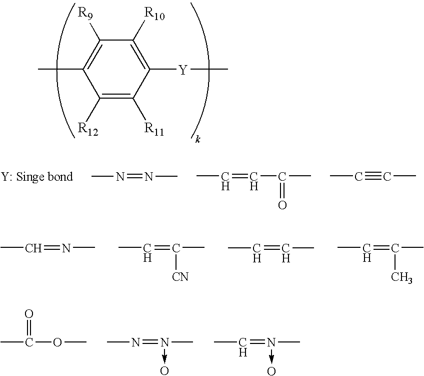
(wherein each of R₉, R₁₀, R₁₁ and R₁₂ represents a hydrogen atom or an alkyl group having 1 to 4 carbon atoms and each may be the same or different, and k is a number of 2 or greater).

17. The epoxy resin composition according to claim 13, wherein the mesogenic skeleton is represented by the following formula: 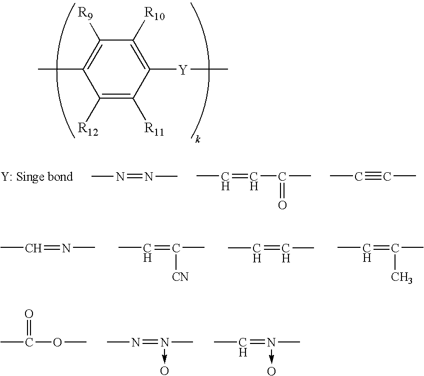
(wherein each of R₉, R₁₀, R₁₁ and R₁₂ represents a hydrogen atom or an alkyl group having 1 to 4 carbon atoms and each may be the same or different, and k is a number of 2 or greater).

18. The epoxy resin composition according to claim 14, wherein the mesogenic skeleton is represented by the following formula: 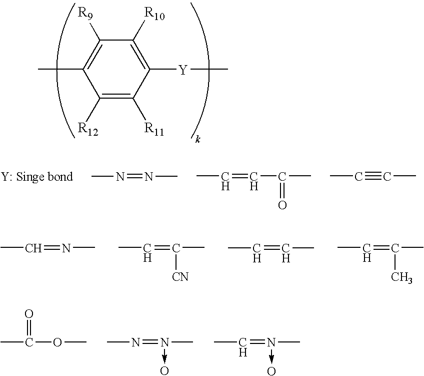
(wherein each of R₉, R₁₀, R₁₁ and R₁₂ represents a hydrogen atom or an alkyl group having 1 to 4 carbon atoms and each may be the same or different, and k is a number of 2 or greater).

19. A cured material obtainable by hardening an epoxy resin composition according to claim 11.

20. The cured material according to claim 19, wherein the cured material has a glass transition temperature of 130° C. or greater.

21. A semi-cured material obtainable by partially-hardening an epoxy resin composition according to claim 11.

22. A prepreg comprising:
a core material; and
a semi-cured material according to claim 21.

23. A composite substrate comprising:
a cured material according to claim 19; and
a metal layer laminated on one surface or both surfaces of the cured material.
